(19) United States
(12) Patent Application Publication
(10) Pub. No.: US 2010/0039626 A1
(43) Pub. Date: Feb. 18, 2010

(54) HANDHELD PROJECTOR

(75) Inventors: WEN-FU WEN, Tu-Cheng (TW); CHENG-HUNG CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/354,694

(22) Filed: Jan. 15, 2009

(30) Foreign Application Priority Data
Aug. 14, 2008 (CN) 200810303759.1

(51) Int. Cl. G02B 7/04; G03B 21/14

(52) U.S. Cl. 353/101; 359/823

(57) ABSTRACT

A handheld projector includes a housing, a projection lens module having an optical axis and a focusing member fixed inside the housing. The projection lens module includes an inner barrel fixed inside the housing, an outer barrel sleeving the inner barrel, and a projection lens received in the inner barrel. The outer barrel includes a first sidewall. At least one cam groove is defined in the first sidewall. A guide bar extends from the first sidewall. The projection lens includes cam follower corresponding to the cam groove. The focusing member includes a body portion with a first surface facing the projection lens module. A guide groove is defined on the first surface corresponding to the guide bar. The guide groove is tilted relative to the optical axis. Each cam follower is plugged into the corresponding cam groove. The guide bar is plugged into the guide groove.

### BACKGROUND

1. Technical Field

The present disclosure relates to projecting technology and, particularly, to a handheld projector.

2. Description of the Related Art

Projectors are widely used in different places, such as theaters, classrooms, outdoor displays and conference rooms etc. Particularly, with the development of projector miniaturization, a handheld projector, carried in a pocket or even integrated in mobile terminals such as mobile phones, personal digital assistants (PDAs) and digital cameras, allow a user to project an image onto a surface wherever he wants to.

Generally, such handheld projectors include a projection lens module with a focusing ring. The user may rotate the focusing ring to obtain a focused image projected on a surface. However, one-handed operation of the handheld projectors is difficult, particularly when manipulating the focus ring right or left.

Therefore, what is needed is a handheld projector which can overcome the above-mentioned problem.

### BRIEF DESCRIPTION OF THE DRAWINGS

FIG. 1 is a partial, isometric view of a handheld projector, according to an exemplary embodiment.

FIG. 2 is a partial, isometric view of the handheld projector of FIG. 1 viewed from another angle.

FIG. 3 is an exploded, isometric view of the handheld projector of FIG. 1.

FIG. 4 is an exploded, isometric view of the handheld projector of FIG. 2.

### DETAILED DESCRIPTION

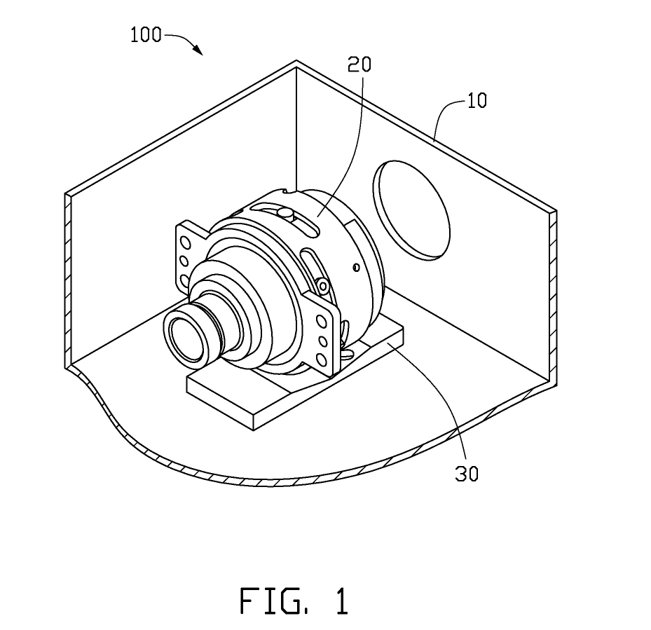

Referring to FIG. 1, the handheld projector 100 includes a housing 10, a projection lens module 20, and a focusing member 30.

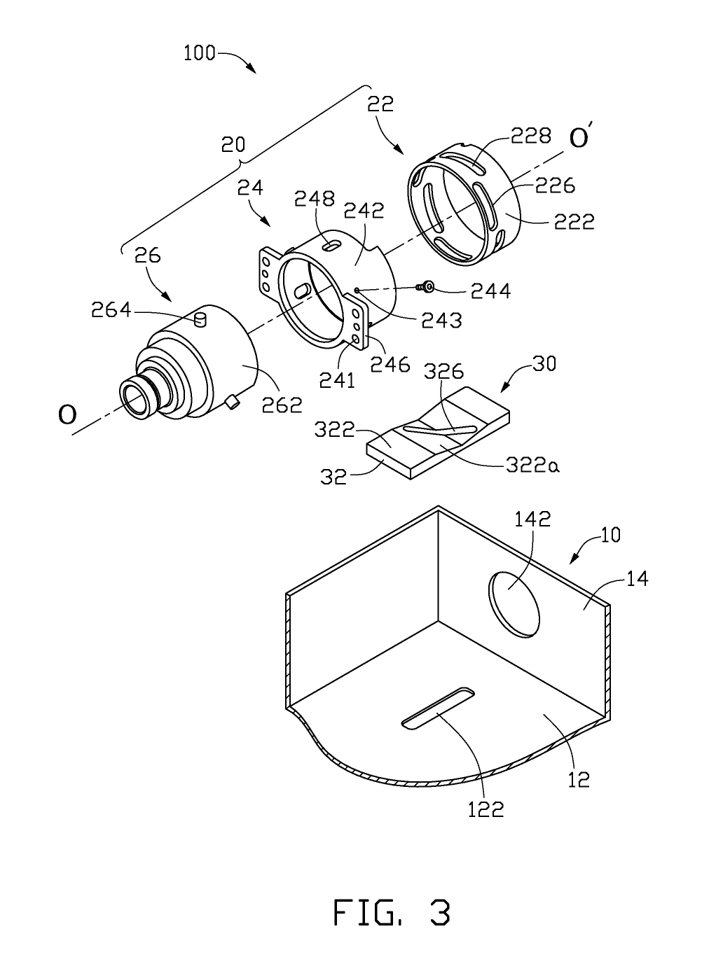

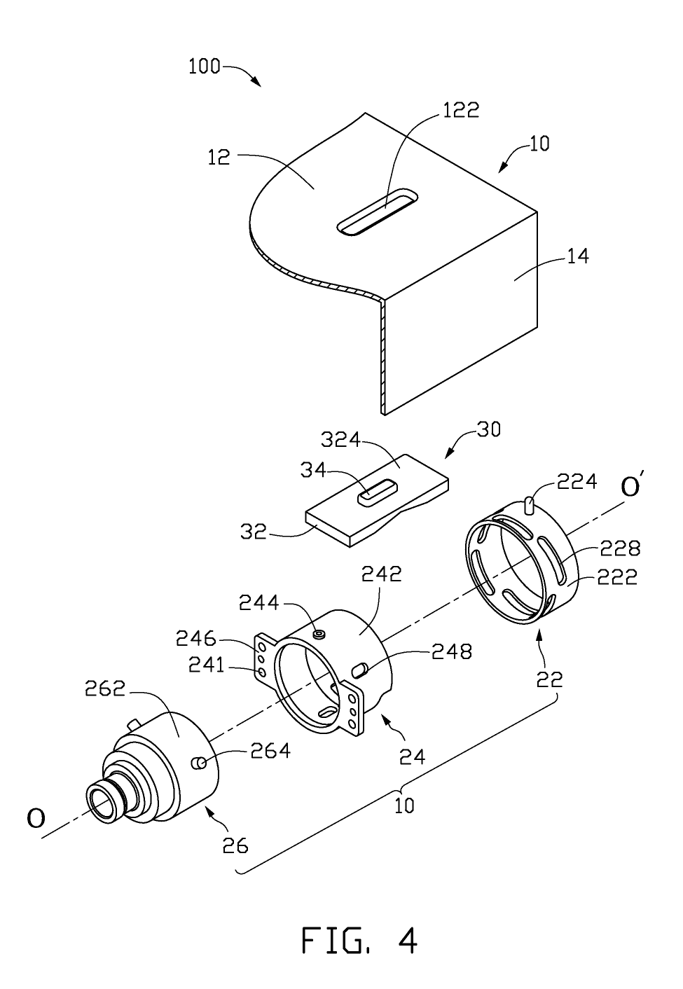

Referring to FIGS. 1, 3 and 4, the housing 10 includes a supporting portion 12 and a covering portion 14 perpendicularly extending from the supporting portion 12. A guiding slot 122 is defined in the supporting portion 12. An aperture 142 is defined in the covering portion 14 corresponding to the guiding slot 122. The projection lens module 20 and the focusing member 30 are positioned inside the housing 10. The projection lens module 20 faces the aperture 142. The focusing member 30 is movably connected to the supporting portion 12 and is configured for moving along the guiding slot 122. The projection lens module 20 is configured for projecting an image onto a surface (not shown) through the aperture 142.

The projection lens module 20 includes an outer barrel 22, an inner barrel 24, and a projection lens 26 having an optical axis OO′. The outer barrel 22 sleeves the inner barrel 24. The projection lens 26 is received in the inner barrel 24. The outer barrel 22, the inner barrel 24, and the projection lens 26 are concentric and the center line thereof is aligned with the optical axis OO′ of the projection lens 26.

The outer barrel 22 includes a first sidewall 222 and a guide bar 224 radially extending from the first sidewall 222 away from the optical axis OO′. Three retaining slots 226 are defined in the first sidewall 222 along the circumference of the first sidewall 222 and are substantially equidistant from each other around the first sidewall 222. Three cam grooves 228 are defined in the first sidewall 222. The cam grooves 228 are defined being tilted relative to the optical axis OO′.

The inner barrel 24 includes a second sidewall 242, three retaining fasteners 244, such as screws or bolts, and two tabs 246 extending from a side of the second sidewall 242. Three retaining through holes 243 corresponding to the three retaining fasteners 244 are radially defined in the second sidewall 242 and are equidistant from each other around the second sidewall 242. The retaining through holes 243 correspond to the three retaining slots 226 respectively. Each retaining fastener 244 passes through the corresponding retaining slot 226 and is engaged in the corresponding retaining through hole 243 so that the outer barrel 22 is mounted to the inner barrel 24. As a result, the movement of the outer barrel 22 along the optical axis OO′ is restricted by the retaining fastener 244. Three linear slots 248 are defined radially in the second sidewall 242 corresponding to the three cam grooves 228. Three fixing through holes 241 are defined in each tab 246, with an axial direction of each of the fixing through holes 241 parallel to the optical axis OO′. Six screws (not shown) pass through the fixing though holes 241 and are engaged in an optical engine (not shown) of the handheld projector 100 so that the projection lens module 20 is secured to the optical engine of the handheld projector 100.

The projection lens 26 includes a third sidewall 262 and three cam followers 264 radially extending from the third sidewall 262 away from the optical axis OO′. The cam followers 264 correspond to the linear slots 248 and the cam grooves 228. Each cam follower 264 passes through the corresponding linear slot 248 and the corresponding cam groove 228 so that the projection lens 26 is received in the inner barrel 24.

The focusing member 30 includes a body portion 32 and a protrusion 34 corresponding to the guiding slot 122. The body portion 32 includes a first surface 322 facing the projection lens module 20 and a second surface 324 opposite to the first surface 322. The protrusion 34 extends from the second surface 324. A V-shaped depressed portion 322a is formed on the first surface 322 and faces the first sidewall 222. A guide groove 326 is defined in the V-shaped depressed portion 322a. The guide groove 326 is defined being tilted relative to the optical axis OO′. The guide bar 224 is plugged into the guide groove 326 and tightly contacts the bottom of the guide groove 326 so that the outer barrel 22 is rotated around the optical axis OO′ with movement of the focusing member 30 along the guiding slot 122. The second surface 324 abuts against the supporting portion 12 and the protrusion 34 protrudes from the guiding slot 122.

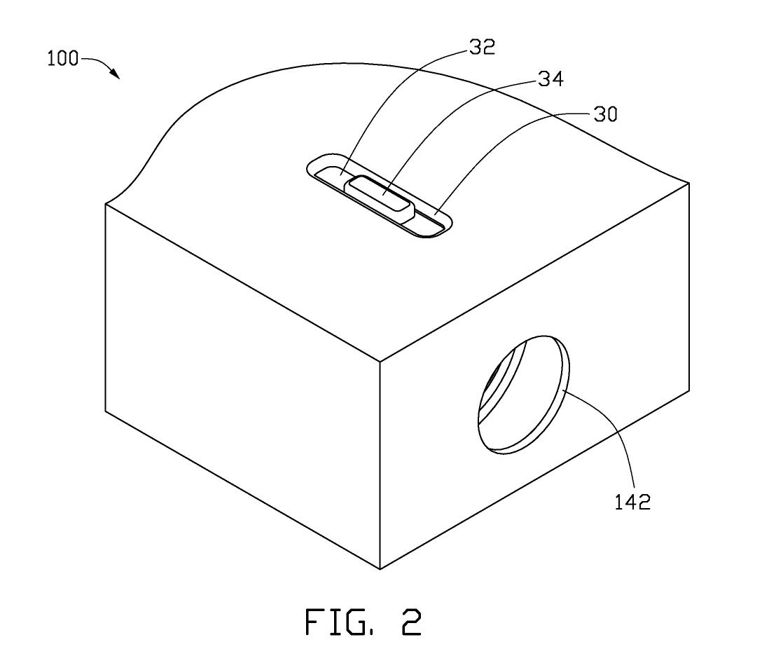

Referring to FIGS. 1-4, the protrusion 34 is pulled by one hand of a user so that the focusing member 30 moves along the guiding slot 122. The guide bar 224 is moved by engagement between the guide bar 224 and the guide groove 326. The outer barrel 22 is rotated around the optical axis OO′ due to the movement of the guide bar 224. Each cam follower 264 is pulled by the sidewall of the corresponding cam groove 228 with the rotation of the outer barrel 22 so that each cam follower 264 slides along the corresponding linear slot 248. As a result, the projection lens 26 is rotated towards or away from the aperture 142 along the optical axis OO′ during focusing. In this embodiment, if the protrusion 34 is pulled towards the aperture 142, the outer barrel 22 rotates clockwise around the optical axis OO′, and the projection lens 26 moves away from the aperture 142. Otherwise, if the protrusion 34 is pulled away from the aperture 142, the outer barrel 22 rotates counterclockwise around the optical axis OO′, and the projection lens 26 moves towards the aperture 142. Therefore, it is easy for the user to focus the projected image.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A handheld projector comprising:
a housing;
a projection lens module having an optical axis, comprising:
an inner barrel fixed inside the housing;
an outer barrel sleeving the inner barrel, the outer barrel comprising a first sidewall, at least one cam groove defined in the first sidewall and being tilted relative to the optical axis, and a guide bar extending from the first sidewall radially away from the optical axis; and
a projection lens received in the inner barrel, the projection lens comprising at least one cam follower corresponding to the at least one cam groove; and
a focusing member fixed inside the housing and comprising a body portion having a first surface facing the projection lens module, a guide groove defined on the first surface corresponding to the guide bar, the guide groove being tilted relative to the optical axis;
wherein each cam follower is plugged into the corresponding cam groove, the guide bar is plugged into the guide groove.

2. The handheld projector as claimed in claim 1, wherein the housing comprises a supporting portion and a covering portion perpendicularly extending from the supporting portion, a guiding slot is defined in the supporting portion, an aperture is defined in the covering portion corresponding to the guiding slot, the projection lens module is fixed inside the housing and faces the aperture, the focusing member is movably connected to the supporting portion inside the housing, and part of the focusing member is exposed and operated from the guiding slot.

3. The handheld projector as claimed in claim 2, wherein the focusing member further comprises a protrusion corresponding to the guiding slot, the body portion comprises a second surface opposite to the first surface, the protrusion extends from the second surface, the second surface abuts against the supporting portion and the protrusion protrudes from the guiding slot.

4. The handheld projector as claimed in claim 1, wherein a V-shaped depressed portion is formed on the first surface and faces the first sidewall, the guide groove is defined in the V-shaped depressed portion corresponding to the guide bar, the guide bar is defined being tilted relative to the optical axis.

5. The handheld projector as claimed in claim 1, wherein the inner barrel comprise a second sidewall, at least one linear slot is defined in the second sidewall corresponding to the cam groove and the cam follower along the optical axis, each cam follower passes through the corresponding linear slot and the corresponding cam groove so that the projection lens is received in the inner barrel.

6. The handheld projector as claimed in claim 5, wherein at least one retaining slot is defined in the first sidewall along the circumference of the first sidewall, the inner barrel further comprises at least one fastener corresponding to the at least one retaining slot, at least one retaining through hole is defined in the second sidewall corresponding to the at least one fastener, each retaining fastener passes through the corresponding retaining groove and the corresponding retaining through hole so that the outer barrel is fixed to the inner barrel.

7. The handheld projector as claimed in claim 1, wherein the inner barrel is fixed inside the housing by screw joint.

8. The handheld projector as claimed in claim 5, wherein the at least one cam groove comprises three cam grooves, the at least one cam follower comprises three cam followers corresponding to the three cam grooves, the at least one linear slot comprises three linear slots defined in the second sidewall corresponding to the three cam grooves and the three cam followers along the optical axis, each cam follower passes through the corresponding linear slot and the corresponding cam groove so that the projection lens is received in the inner barrel.

9. The handheld projector as claimed in claim 6, wherein the at least one retaining slot comprises three retaining slots defined in the first sidewall along the circumference of the first sidewall and are substantially equidistant from each other around the first sidewall, the at least one fastener comprises three fasteners corresponding to the three retaining slots, the at least one retaining through hole comprises three retaining through holes defined in the second sidewall corresponding to the three fastener, each retaining fastener passes through the corresponding retaining groove and the corresponding retaining through hole so that the outer barrel is fixed to the inner barrel.
